(19) United States
(12) Patent Application Publication
(10) Pub. No.: US 2025/0055490 A1
(43) Pub. Date: Feb. 13, 2025

(54) METHOD TO MITIGATE INTERFERENCE OF WIRED CONNECTIONS ON CELLULAR WIRELESS QUALITY

(71) Applicant: Apple Inc., Cupertino, CA (US)

(72) Inventors: Murali Mohan CHAKKA, Los Gatos, CA (US); Baohua ZHENG, San Diego, CA (US); Ioannis PEFKIANAKIS, San Jose, CA (US); Prashant H. VASHI, San Jose, CA (US); Amith Kumar NAGARAJ, Santa Clara, CA (US); Karan R. SACHDEV, Santa Clara, CA (US); Muthukumaran DHANAPAL, Sunnyvale, CA (US); Sharad GARG, San Jose, CA (US); Vijay GADDE, San Jose, CA (US); Tarakkumar G. DHANANI, San Jose, CA (US); Sanjeevi BALASUBRAMANIAN, San Jose, CA (US)

(21) Appl. No.: 18/731,986

(22) Filed: Jun. 3, 2024

Related U.S. Application Data
(60) Provisional application No. 63/518,870, filed on Aug. 10, 2023.

(51) Int. Cl. H04B 1/10; H04B 1/04

(52) U.S. Cl. CPC H04B 1/109; H04B 1/0475; H04B 1/1009; H04B 1/1027; H04B 1/1081

(57) ABSTRACT

This application sets forth techniques for mitigating radio frequency (RF) interference from wired connections on cellular wireless reception quality, including pre-emptively determining when to perform RF interference mitigation based on various factors. An interference mitigation module in the wireless device determines whether to perform an interference mitigation procedure based on active and/or imminent use of a high-speed wired connection port for data transfer in parallel with a cellular wireless connection that uses a mid-frequency RF band or a high-frequency RF band. The wireless device determines a target cell in a low-frequency RF band and biases measurement reports sent to a cellular wireless network to handover and keep the cellular wireless connection to the target cell in the low-frequency RF band while a high-speed wired connection is active.

### CROSS-REFERENCE TO RELATED APPLICATIONS

The present application claims the benefit of U.S. Provisional Application No. 63/518,870, entitled “METHOD TO MITIGATE INTERFERENCE OF WIRED CONNECTIONS ON CELLULAR WIRELESS QUALITY,” filed Aug. 10, 2023, the content of which is incorporated by reference herein in its entirety for all purposes.

### FIELD

The described embodiments set forth techniques for mitigating radio frequency (RF) interference from wired connections on cellular wireless reception quality, including pre-emptively determining when to perform RF interference mitigation based on various factors.

### BACKGROUND

A cellular wireless device often includes wired connection ports to allow for power recharging of internal battery storage and to transfer data between the cellular wireless device and an external device via a wired connection separate from a cellular (or non-cellular) wireless connection. The wired connection is typically used for high speed data transfer, such as to a display device or between the cellular wireless device and an external storage device, such as a solid state drive (SSD). Communication standards for wired connections continue to increase in data transfer rates with each new generation, e.g., to support displays with higher resolution and refresh rates and external storage devices with increased storage capacity. High data transfer rates can also result in increased amounts of radio frequency (RF) interference in certain RF bands used for cellular wireless communication. Cellular wireless receivers can be positioned relatively close to wired connection ports, resulting in substantial RF interference in some scenarios. There exists a need for techniques to mitigate RF interference from wired connections of a wireless device impacting cellular wireless reception quality.

### SUMMARY

This Application sets forth techniques for mitigating radio frequency (RF) interference from wired connections on cellular wireless reception quality, including pre-emptively determining when to perform RF interference mitigation based on various factors. A wireless device includes a high-speed wired connection port and a cellular wireless transceiver. In some embodiments, the high-speed wired connection port is a universal serial bus (USB) type C connection port configurable to operate at data transfer rates exceeding 5 Gigabits per second (Gbps). An interference mitigation module in the wireless device, e.g., implemented in software, firmware, and/or hardware on one or more processors of the wireless device, monitors interference mitigation criteria to determine whether to perform an interference mitigation procedure. Exemplary interference mitigation criteria include: i) active use of the high-speed wired connection port for data transfer, ii) cellular wireless receiver performance parameters relative to corresponding thresholds, iii) a type of active cellular connection type, iv) an external peripheral device type connected via the high-speed wired connection port, v) one or more RF band(s) actively used for cellular communication, vi) an application type for an application using the cellular connection, and/or vii) an application type for an application using the high-speed wired connection port for data transfer. When one or more criteria for interference mitigation are satisfied, e.g., based on detecting active use of a wired connection between the wireless device and a peripheral device and a parallel cellular wireless connection using a mid-frequency RF band, e.g., between 1.4 and 2.2 Gigahertz (GHz), or a high-frequency RF band, e.g., between 2.3 and 5.0 GHz or above 5.0 GHz, the wireless device performs an interference mitigation procedure to move the cellular wireless connection from the mid-frequency RF band or the high-frequency RF band to a low-frequency RF band, e.g., below 1.0 GHz. The wireless device can bias measurement reports sent to a cellular wireless network to cause the cellular wireless network to handover the cellular wireless connection from a serving cell in the mid-frequency RF band or a high-frequency RF band to a target cell in the low-frequency RF band and to keep the cellular wireless connection on the target cell in the low-frequency RF band while the wired connection is actively used. In some embodiments, the wireless device, when the cellular wireless connection is used for data reception, monitors for loading and/or congestion in a target cell and in a serving cell to determine whether to cause the cellular wireless network to handover from the serving cell to the target cell, e.g., to ensure performance of the data connection via the target cell in the low-frequency RF band is likely to equal or exceed performance via the serving cell in the mid-frequency or high-frequency RF band. In some embodiments, the wireless device measures target cells that use different radio access technologies (RATs) to determine target cell RAT to which to cause the cellular wireless network to handover the cellular wireless connection. In some embodiments, the wireless device determines whether the wireless device is configured to support non-cellular voice or video connections, e.g., via Wi-Fi calling, and determines whether to perform a cellular handover of the cellular connection to a non-cellular wireless network.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different components of an exemplary system configured to implement the various techniques described herein, according to some embodiments.

FIG. 2 illustrates a table of exemplary interference between a wired connection and a cellular wireless connection of a wireless device, according to some embodiments.

FIGS. 3A and 3B illustrate block diagrams of exemplary modules for managing interference in a wireless device, according to some embodiments.

FIG. 4 illustrates a diagram of an exemplary timeline for interference mitigation performed by a wireless device, according to some embodiments.

FIG. 5A illustrates a flowchart of an example of interference mitigation managed by a wireless device, according to some embodiments.

FIG. 5B illustrates an exemplary state diagram for interference mitigation performed by a wireless device, according to some embodiments.

FIG. 6 illustrates a flowchart of an exemplary method for interference mitigation performed by a wireless device, according to some embodiments.

FIG. 7 illustrates a block diagram of exemplary elements of a wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

This application sets forth techniques for mitigating radio frequency (RF) interference from wired connections on cellular wireless reception quality, including pre-emptively determining when to perform RF interference mitigation based on various factors. A wireless device includes a high-speed wired connection port and a cellular wireless transceiver. In some embodiments, the high-speed wired connection port is a universal serial bus (USB) type C connection port configurable to operate at data transfer rates exceeding 5 Gbps and/or to charge a battery internal to the wireless device. The wired connection port can be used to connect the wireless device to different external peripheral devices, such as to a high resolution display, a solid state drive (SSD), a communication hub, or an accessory device, e.g., a keyboard, mouse, or microphone. The wireless device can use both a cellular wireless connection, via the cellular wireless transceiver, and a wired connection, via the high-speed wired connection port, in parallel. Communication standards for wired connections continue to increase in data transfer rates with each new generation, e.g., to support displays with higher resolution and refresh rates and external storage devices with increased storage capacity. High data transfer rates through a wired connection via the high-speed wired connection port can result in substantial amounts of radio frequency (RF) interference in mid-frequency RF bands and/or high-frequency RF bands used for cellular wireless communication, as cellular wireless antennas and receivers can be positioned relatively close to the high-speed wired connection port.

An interference mitigation module in the wireless device, e.g., implemented in software on one or more processors of the wireless device, monitors interference mitigation criteria to determine whether to perform an interference mitigation procedure. Exemplary interference mitigation criteria include: i) active use of the high-speed wired connection port for data transfer, ii) cellular wireless receiver performance parameters relative to corresponding thresholds, iii) a type of active cellular connection type, iv) an external peripheral device type connected via the high-speed wired connection port, v) one or more RF band(s) actively used for cellular communication, vi) an application type for an application using the cellular connection, and/or vii) an application type for an application using the high-speed wired connection port for data transfer. In some embodiments, an application processor of the wireless device provides an indication to the interference mitigation module when the high-speed wired connection port is actively used, and in some cases the application and/or an external peripheral device connection using the connection. When one or more criteria for interference mitigation are satisfied, e.g., based on detecting i) active use of a wired connection between the wireless device and a peripheral device and ii) a parallel cellular wireless connection using a mid-frequency RF band, e.g., between 1.4 and 2.2 Gigahertz (GHz) or a high-frequency RF band, e.g., between 2.3 and 5.0 GHz or above 5.0 GHz, the wireless device performs an interference mitigation procedure to move the cellular wireless connection from the mid-frequency RF band or the high-frequency RF band to a low-frequency RF band, e.g., below 1.0 GHZ.

The wireless device can perform measurements of neighbor cells available for a currently used radio access technology (RAT) and, in some cases, perform measurements of neighbor cells available via a different RAT. Measurement of neighbor cells can be performed by the wireless device even when such measurements would not be triggered by wireless communication standards, e.g., when measurement trigger thresholds configured by a cellular wireless network to which the wireless device is connection have not been necessarily met. Based on the measurements, the wireless device can determine a target cell that is likely to provide better performance for the cellular wireless connection than the current serving cell. The wireless device can bias measurement reports sent to a cellular wireless network to favor a determined target cell to cause the cellular wireless network to handover the cellular wireless connection from the currently used serving cell in the mid-frequency RF band or the high-frequency RF band to the determined target cell in the low-frequency RF band. After handover occurs, the wireless device can also bias measurement reports sent to the cellular wireless network to favor the new serving cell to keep the cellular wireless connection on the new serving cell in the low-frequency RF band while the wired connection is actively used. The wireless device can determine to stop performance of the interference mitigation procedure, e.g., cease biasing measurement reports and return to sending unbiased measurement reports to the cellular wireless network, after determining active use of the high-speed wired connection port has ended.

In some embodiments, the wireless device biases measurement reports when i) a cellular voice or video call is ongoing, ii) active data transfer via the high-speed wired connection is occurring, iii) the serving cell uses a mid-frequency RF band or a high-frequency RF band, and received signal strength and/or quality for the cellular wireless connection satisfy certain conditions, e.g., corresponding strength and/or quality thresholds are satisfied. In some embodiments, the wireless device biases measurement reports when i) a cellular data connection is ongoing, ii) active data transfer via the high-speed wired connection is occurring, iii) the serving cell uses a mid-frequency RF band or a high-frequency RF band, and received signal strength and/or quality for the cellular wireless connection satisfy certain conditions, e.g., corresponding strength and/or quality thresholds are satisfied. In some embodiments, the wireless device, when the cellular wireless connection is used for data reception, monitors for loading and/or congestion in a target cell and in a serving cell to determine whether to cause the cellular wireless network to handover from the serving cell to the target cell, e.g., to ensure performance of the data connection via the target cell in the low-frequency RF band is likely to equal or exceed performance via the serving cell in the mid-frequency RF band or the high-frequency RF band. In some embodiments, when biased measurements sent to the cellular wireless network fail to cause the cellular wireless network to handover the cellular wireless connection to a target cell, and the cellular wireless connection is used for data transfer (and not for a real-time voice or video call), the wireless device can trigger a re-establishment procedure to sever the cellular wireless connection to the currently used serving cell in the mid-frequency RF band or the high-frequency RF band and connect to a target cell in a low-frequency RF band as part of a cell selection procedure. In some embodiments, the wireless device measures target cells that use different radio access technologies (RATs) to determine target cell RAT to which to cause the cellular wireless network to handover the cellular wireless connection. In some embodiments, the wireless device determines whether the wireless device is configured to support non-cellular voice or video connections, e.g., via Wi-Fi calling, and determines whether to perform a cellular handover of the cellular connection to a non-cellular wireless network.

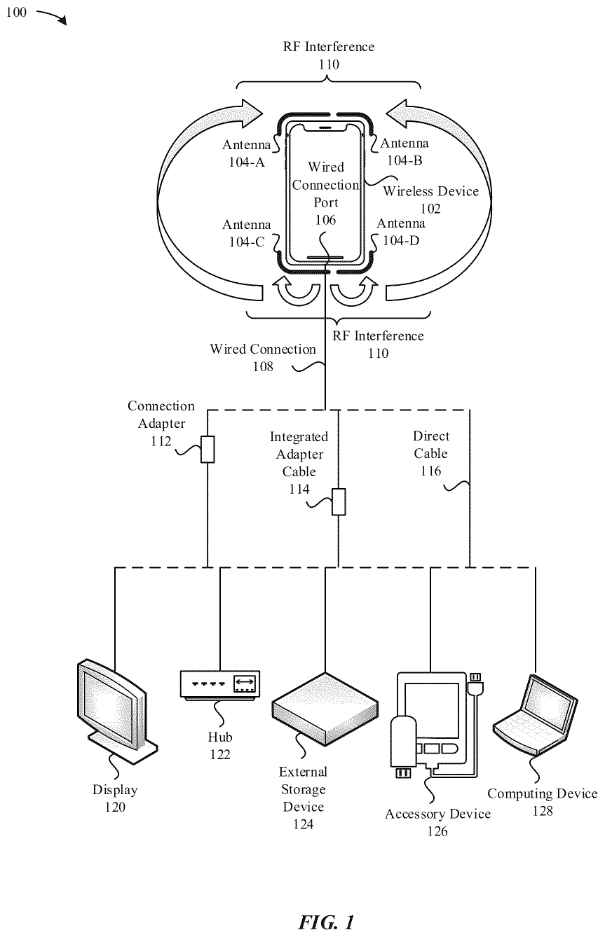

These and other embodiments are discussed below with reference to FIGS. 1-7; however, those skilled in the art will readily appreciate that the detailed description given herein with respect to these figures is for explanatory purposes only and should not be construed as limiting.

FIG. 1 illustrates a block diagram of different components of a system 100 that is configured to implement the various techniques described herein, according to some embodiments. More specifically, FIG. 1 illustrates a high-level overview of the system 100, which, as shown, includes a wireless device 102, which can also be referred to as a device, a mobile wireless device, a mobile device, a user equipment (UE) and the like, which can connect via a wired connection 108 to an external peripheral device, such as a display 120, a hub 122, an external storage device 124, and accessory device 126, or a computing device 128. Exemplary displays 120 can include high definition displays that support 2K, 4K, 5K, 6K or higher resolutions and various refresh rates. Exemplary hubs 122 can include devices to support connections via other wired communication protocols, e.g., Ethernet, or to provide ports for transfer of data to/from secure digital (SD) and/or CompactFlash (CF) memory cards. Exemplary external storage devices 124 can include solid state drives (SSDs), hard disk drives (HDDs), and network attached storage (NAS) devices. Exemplary accessory devices 126 can include universal serial bus (USB) pen/thumb drives, keyboards, mice, microphone, and video cameras. Exemplary computing devices 128 can include laptop computers or desktop computers, such as when the wired connection 108 is used to provide a personal hotspot between a cellular wireless connection of the wireless device 102 and a wired connection 108 to the computing device 128. The wireless device 102 can represent a cellular-capable computing device (e.g., an iPhone® or an iPad® by Apple®) that includes a wired connection port 106, which in some embodiments can operate using a USB 3.0 or later, also referred to as USB-C, wired communication protocol. In some cases, the external peripheral device can connect to the wired connection port 106 of the wireless device 102 via a direct cable 116, e.g., using a USB-C to USB-C cable to connect the wireless device 102 to an external storage device 124, such as a solid state drive (SSD), to a display 120 that includes a USB-C input, or to a computing device 128 with a USB-C input. In some cases, the external peripheral device can connect to the wired connection port 106 of the wireless device 102 via a connection adapter 112, e.g., using a USB-C to DisplayPort adapter to connect the wireless device 102 to a display 120 that requires a DisplayPort connection. In some cases, the external peripheral device can connect to the wired connection port 106 of the wireless device 102 via an integrated adapter cable 114, e.g., using a USB-C (USB 3.0) to USB-A (USB 2.0) cable to connect the wireless device 102 to an accessory device 126. Additional connection adapters 112 or integrated adapter cables 114 can also be used, such as for a USB-C to HDMI wired connection between the wireless device 102 and an external peripheral device. The wired connection port 106 can provide a wired connection 108 that transfers data at relatively high rates in some cases, e.g., at multiple Gigabits per second (Gbps) rates. Communication at high data rates can result in radio frequency radio frequency (RF) emissions at the wired connection port and/or along the wired connection 108 that result in RF interference 110 that can be received via one or more antennas 104 of the wireless device 102.

The wireless device 102 can include processing circuitry, which can include one or more processor(s), memory storage, and baseband wireless circuitry used for transmission and reception of cellular wireless radio frequency signals. The baseband wireless circuitry can include analog hardware components, such as antennas 104 and amplifiers, as well as digital processing components, such as signal processors (and/or general/limited purpose processors) and associated memory. Antennas can be positioned at different locations on the wireless device 102, such as antennas 104-C, 104-D, which can be referred to as a lower antenna pair 104-C/D, located nearest the wired connection port 106, and antennas 104-A, 104-B, which can be referred to as an upper antenna pair 104-A/B, located further away from the wired connection port 106. RF interference generated by data communication via the wired connection port 106 and the wired connection 108 to a peripheral external device can be received by one or more antennas 104-A/B/C/D of the wireless device 102 and can adversely affect cellular wireless performance for reception of cellular wireless signals, e.g., for a voice or video call or for a data connection.

The wireless device 102 can include one or more processors, e.g., an application processor that can implement a main operating system (OS) configured to execute applications (e.g., native OS applications and user applications) and a baseband cellular wireless processor that can manage cellular wireless connections. The baseband processor of the wireless device 102 can include a baseband OS that is configured to manage hardware resources of the baseband wireless circuitry (e.g., a processor, a memory, different radio components, etc.) and implement a baseband manager that is configured to interface with one or more secure elements, e.g., a subscriber identity module (SIM) card and/or an embedded universal integrated circuit card (eUICC) storing one or more electronic SIMs (eSIMs) for access to cellular wireless services. In some embodiments, the application processor can include an activity monitoring module that can detect an active data connection via the wired connection port 106 (or imminent use of an active data connection based on initiation of particular applications) and provide information regarding the active (or pending active) data connection to an interference management module resident on the application processor and/or on the baseband cellular wireless processor. The interference management module can monitor a set of one or more criteria for interference management including information from the activity monitoring module to determine whether to enable or disable an interference management procedure, which can be implemented on the application processor and/or on the baseband cellular wireless processor.

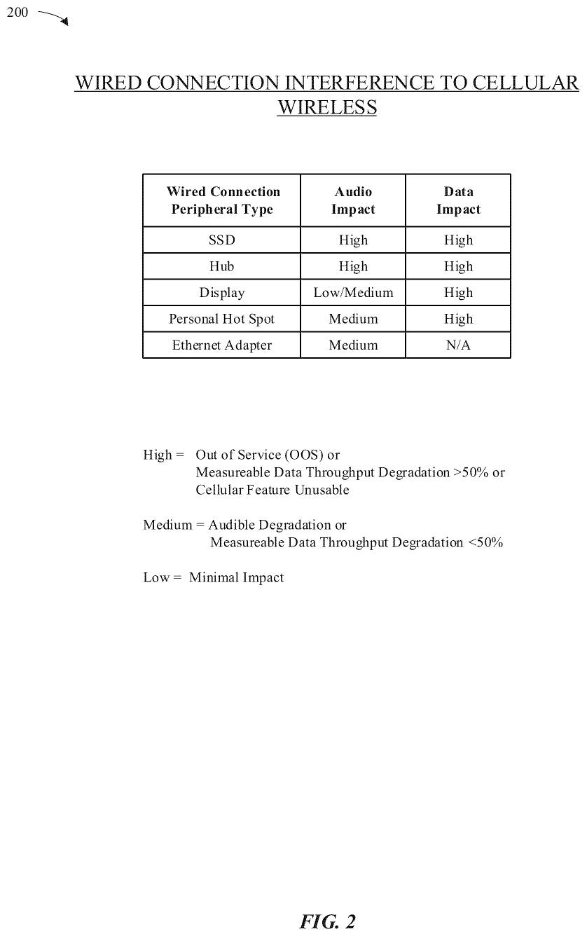

FIG. 2 illustrates a table 200 of exemplary RF interference 110 between a wired connection 108 via a wired connection port 106 and a cellular wireless connection of a wireless device 102. Different types of peripheral external devices that can operate at high speed data transfer rates via the wired connection 108 can result in varying amounts of RF interference 110 into reception of cellular wireless signals via antennas 104 of the wireless device 102, particularly when the cellular wireless connection uses a mid-frequency RF band (in the 1.4 to 2.2 GHz range) or a high-frequency RF band (in the 2.3 to 5.0 GHz range or above the 5.0 GHz range). The RF interference 110 generated by active data transfer over the wired connection 108 can affect both audio quality for a voice call or video call using the cellular wireless connection as well as data transfer rates in the downlink direction (from the cellular wireless network to the wireless device 102) for a data-centric cellular wireless connection. For example, in-field test measurements have shown that data transfer at greater than 5 Gbps via the wired connection 108 to an external display 120 can result in an increased noise floor level of 5 to 10 dB at the upper antenna pair 104-A/B and 5 to 35 dB at the lower antenna pair 104-C/D when the cellular wireless connection operates in the fifth generation (5G) new radio (NR) RF band 66 with downlink communication between 2.1 and 2.2 GHz. When the wireless device 102 operates at a periphery of a cell, the downlink received signal strength, e.g., measured based on a reference signal received power (RSRP) level, can be approximately −120 dBm. An increase in the noise floor at the cellular wireless receivers of the wireless device 102 when operating with low received signal power can result in audible levels of distortion, corrupted video signals, and measureable data throughput degradation.

The table 200 of FIG. 2 characterizes the impact of RF interference 110 generated by a wired connection 108 to both a voice/video call of a cellular wireless connection and data transfer via a cellular wireless connection. A high impact from RF interference 110 can be characterized to result in i) an out-of-service (OOS) condition for cellular wireless, where a cellular wireless connection can drop and be unable to be re-established, ii) a measureable data throughput degradation of more than 50%, or iii) a cellular feature being unusable. A medium impact from RF interference 110 can be characterized to result in i) an audio degradation for a voice/video call, or ii) a measureable data throughput degradation of less than 50%. A low impact from RF interference can be characterized to have minimal impact on performance of a voice/video call or data throughput performance. As indicated in table 200, substantial impacts have been observed when the cellular wireless connection operates in a mid-frequency RF band or a high-frequency RF band and active data transfer occurs via the wired connection port 106 to different peripheral external devices. Wired data transfer, typically at high rates, to an external storage device 124, such as an SSD, can result in high impact to both audio performance and data throughput performance. Similarly wired data communication to an external hub can also result in high impact to both audio performance and data throughput performance. An active wired connection 108 to a display 120 via the wired connection port 106 can have a high impact on data throughput performance and a low to medium impact on audio performance. Connecting a computing device 128 to the wireless device 102 via the wired connection port 106 to provide a personal hot spot application (which would also use the cellular wireless connection for data transfer) can also have a high impact on the cellular wireless data throughput, with a medium impact on audio performance via a cellular wireless connection. Similarly, use of an Ethernet adapter for data transfer via the wired connection port 106 has been shown to have a medium impact on audio performance via a parallel cellular wireless connection of a wireless device 102. There exists a need for techniques to mitigate the impact of RF interference 110 from a wired connection 108 via a wired connection port 106 of a wireless device 102 on cellular wireless reception quality for both audio performance of a voice/video call and for data throughput performance of a cellular wireless data connection. Field measurements have shown that low-frequency RF bands (e.g., below 1.0 GHz) can be less impacted by RF interference 110 from a wired connection 108 via a wired connection port 106 of a wireless device 102, e.g., less than 5 dB reduction in signal to interference plus noise ratio (SINR) values, and therefore interference mitigation can seek to favor cellular wireless connections via use of a low-frequency RF band when a wired connection 108 via a wired connection port 106 is active in parallel with a cellular wireless connection.

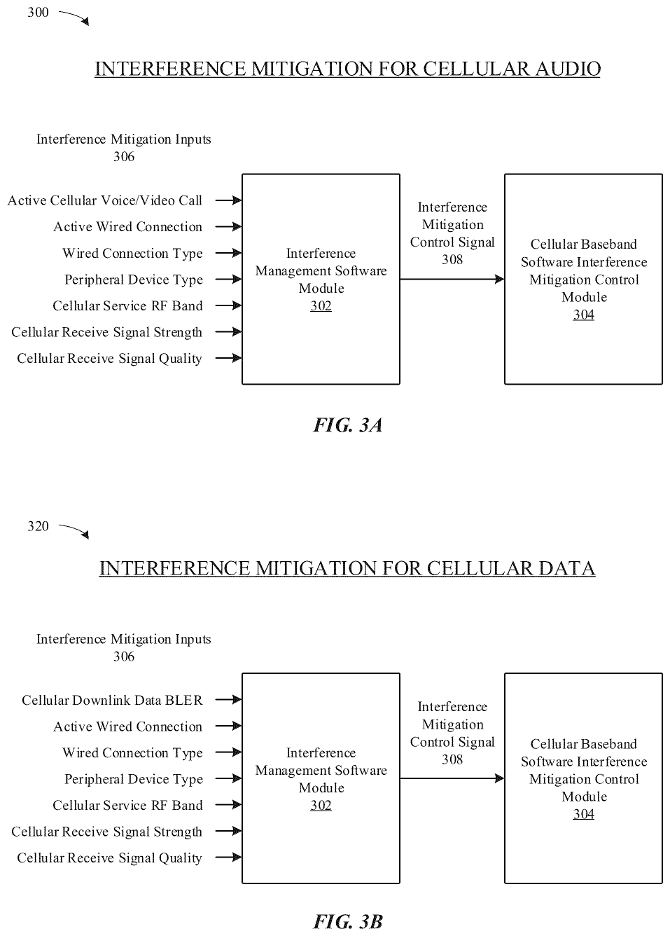

FIG. 3A illustrates a block diagram 300 of exemplary software modules for managing RF interference from a wired connection 108 into a cellular wireless connection that carries audio data, such as for an audio call or accompanying a video call. An interference management software module 302 receives and processes information from a set of interference mitigation inputs 306 to determine an interference mitigation control signal 308 to provide to a cellular baseband software interference mitigation control module 304, which can perform actions of an interference mitigation procedure to reduce the effect of RF interference from the wired connection 108 into the cellular wireless connection. The interference mitigation inputs 306 can include an indication of an active cellular voice/video call, an indication of an active wired connection 108, a wired connection type, a peripheral external device type, an RF band used for the cellular wireless connection, a cellular receive signal strength value, such as a cellular reference signal received power (RSRP) value, a cellular receive signal quality value, such as a cellular reference signal received quality (RSRQ) value. The interference management software module 302 can compare the cellular service strength and/or quality values to corresponding thresholds to determine whether criteria for mitigating RF interference are satisfied. In some embodiments, the interference management software module 302 uses threshold values that differ from those specified by a cellular wireless network for measurement reporting, e.g., to measure and assess performance pre-emptively before a handover would normally occur based on decision of a cellular wireless network. In some embodiments, the interference management software module 302 executes on an application processor of the wireless device 102 and the cellular baseband software interference mitigation control module 304 operates at least in part on a baseband cellular wireless processor. In some embodiments, the interference mitigation control signal includes an indication to enable interference mitigation, an indication of a preferred RF band (or range of frequencies), and/or an indication of an amount to boost measurement values for one or more cells in measurement reports sent to a cellular wireless network in order to cause the cellular wireless network to handover the wireless device from a serving cell in a mid-frequency RF band or a high-frequency RF band to a target cell in a low-frequency RF band. In a normal handover procedure (without boosted measurement values), measurement reports are sent based on a measurement event being triggered (e.g., an A5 measurement event triggers a wireless device to send measurement reports for a serving cell and for a neighbor cell when the serving cell RSRP and/or RSRQ values fall below corresponding first threshold values and the neighbor cell RSRP and/or RSRQ values exceed corresponding second threshold values). Rather than wait for a normal handover procedure to occur, the wireless device 102 can pre-emptively measure neighbor cells (including in some cases those neighbor cells that use different radio access technologies than a current serving cell) before substantial degradation of cellular SNR is observed. In some embodiments, the thresholds for RSRP/RSRQ values for performing measurements with interference mitigation can differ from those normally used. For example, a wireless device 102 operating at a periphery of a serving cell can have RSRP and/or RSRQ levels that fall below corresponding first threshold values associated with cell handover specified by a cellular wireless network; however, a neighbor cell may have RSRP and/or RSRQ levels that do not exceed corresponding second threshold values associated with cell handover. In this scenario, the wireless device 102 could remain on the serving cell and be impacted by RF interference from a wired connection 108. Handover can be preferred to allow the cellular wireless connection to maintain adequate performance, and therefore, adjusted (e.g., biased) measurements can be sent to the cellular wireless network in order to cause a handover from the serving cell to a neighbor cell. In some cases, measurement of neighbor cells can be performed proactively based on presence of an active wired connection 108 (or anticipation of establishment of an active wired connection 108 for an application initiated on the wireless device 102) in parallel with a cellular wireless connection. In some embodiments, biased measurements to favor handover from a serving cell to a neighbor cell can be proactively sent to a cellular wireless network to cause handover based on an expected degradation in performance of a cellular wireless connection, e.g., when an active wired connection 108 is established or anticipated to be established in parallel with the cellular wireless connection based on application monitoring by an application processor of the wireless device 102.

FIG. 3B illustrates a block diagram 320 of exemplary software modules for managing RF interference from a wired connection 108 into a cellular wireless connection communicating cellular packet data, e.g., an internet connection or data streaming. A similar set of interference mitigation inputs 306 are used by an interference management software module 302 to determine whether to perform interference mitigation, with the primary difference being the replacement of detection of an active voice/video call for a cellular wireless audio connection with measurement of a cellular downlink data block error rate (BLER). When a downlink BLER exceeds a BLER threshold in combination with an active wired connection being detected, the wireless device 102 can perform measurements of neighbor cells and determine whether to perform interference mitigation to improve performance of the cellular wireless connection in the presence of RF interference (and/or in anticipation of degradation of performance of the cellular wireless connection due to expected RF interference from an active wired connection). In some embodiments, the active wired connection input indicates the presence of an active wired connection 108 via a wired connection port 106 of the wireless device 102. In some embodiments, the active wired connection indicates initiation or active use of an application that will use an active wired connection 108 via the wired connection port 106 of the wireless device 102.

In a representative embodiments, the interference management software module 302 will send an interference mitigation control signal 308 to the cellular baseband software interference mitigation control module 304 to cause a baseband processor to boost RSRP values for a low-frequency RF band neighbor (target) cell when the following conditions are met: i) an active (or imminently active) wired connection 108 with data transfer via a wired connection port 106 of the wireless device 102, ii) an ongoing voice or video call, e.g., a Voice over Internet Protocol (VOIP) call or a voice/video calling service such as a FaceTime® call via cellular wireless connection of the wireless device 102, or a cellular downlink data BLER exceeding a BLER threshold for a cellular wireless connection of the wireless device 102, iii) use of a mid-frequency RF band or a high-frequency RF band by the serving cell for the cellular wireless connection, iv) a serving cell signal power level, e.g., an RSRP level, below a first threshold, and v) a serving cell signal quality, e.g., an RSRQ level, below a second threshold. In some embodiments, the interference mitigation control signal 308 includes one or more of: i) an indication to enable interference mitigation, ii) an indication of a preferred low-frequency RF band to use for the cellular wireless connection, or iii) an amount (or range of amounts) to boost reported measurements for RSRP levels and/or RSRQ levels for one or more target (neighbor) cells that use the preferred low-frequency RF band. The cellular baseband software interference mitigation control module 304 can apply boost values to RSRP and/or RSRQ levels in measurement reports sent to a cellular wireless network for at least one of the one or more target (neighbor) cells to cause the cellular wireless network to handover the cellular wireless connection from the current serving cell that uses the mid-frequency RF band or the high-frequency RF band to one of the at least one target (neighbor) cells that uses a low-frequency RF band. The cellular baseband software interference mitigation control module 304 can continue to apply boost values to RSRP and/or RSRQ levels in measurement reports sent to a cellular wireless network for the new serving cell in the low-frequency RF band after handover to avoid returning to the previous serving cell in the mid-frequency RF band or the high-frequency RF band while active use of the wired connection 108 continues. The interference management software module 302 can subsequently send another interference mitigation control signal 308 to the cellular baseband software interference mitigation control module 304 to disable interference mitigation and cease applying boost values to the current serving cell in the low-frequency RF band after active use of the wired connection 108 terminates.

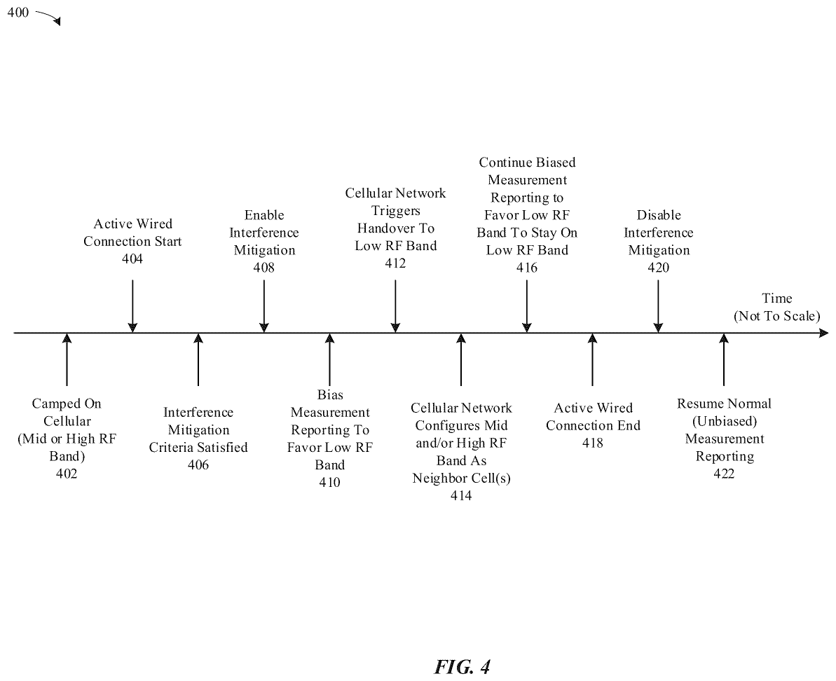

FIG. 4 illustrates a diagram 400 of an exemplary timeline for interference mitigation by a wireless device 102 that includes a wired connection port 106 that supports a wired connection 108 that can be used in parallel with a cellular wireless connection. At 402, the wireless device 102 is camped on a cellular wireless serving cell of a cellular wireless network, the cellular wireless serving cell using a mid-frequency RF band or a high-frequency RF band, while one or more neighbor cells (of the cellular wireless network) use a low-frequency RF band. At 404, an active wired connection 108 via a wired connection port 106 of the wireless device 102 is started (or anticipated to start based on application monitoring). At 406, a set of one or more interference mitigation criteria are satisfied, such as signal strength and/or signal quality levels for the serving cell not satisfying certain threshold levels. At 408, an interference mitigation procedure is initiated, e.g., by an interference management software module 302 sending an interference mitigation control signal 308 to a cellular baseband software interference mitigation control module 304 to enable interference mitigation by the cellular baseband processor. At 410, a cellular baseband processor of the wireless device 102 biases measurement reports sent to the cellular wireless network to favor use of one or more target (neighbor) cells that use a low-frequency RF band. At 412, the cellular wireless network triggers handover of the cellular wireless connection of the wireless device 102 from the serving cell in the mid-frequency RF band or the high-frequency RF band to a target (neighbor) cell in the low-frequency RF band. At 414, the cellular wireless network configures cells in the mid-frequency RF band and the high-frequency RF band as neighbor cells. At 416, the cellular baseband software interference mitigation control module 304 continues to send biased measurement reports to the cellular wireless network to favor the cells (e.g., the serving cell and/or neighbor cells) that use the low-frequency RF band to stay on a cell (or cells) in the low-frequency RF band, thereby forestalling returning to the previous serving cell (or another cell) in the mid-frequency RF band or the high-frequency RF band while the wired connection 108 is active and the cellular wireless connection is vulnerable to RF interference 110 from the active wired connection 108. At 418, the active wired connection 108 terminates, which can be detected by the interference management software module 302. At 420, the interference mitigation procedure terminates, e.g., by the interference management software module 302 sending a second interference mitigation control signal 308 to the cellular baseband software interference mitigation control module 304 to disable interference mitigation by the cellular baseband processor. At 422, the cellular baseband processor of the wireless device 102 resumes normal (unbiased) measurement reporting of signal strength and/or signal quality values for the serving cells and neighbor cells of the wireless device 102.

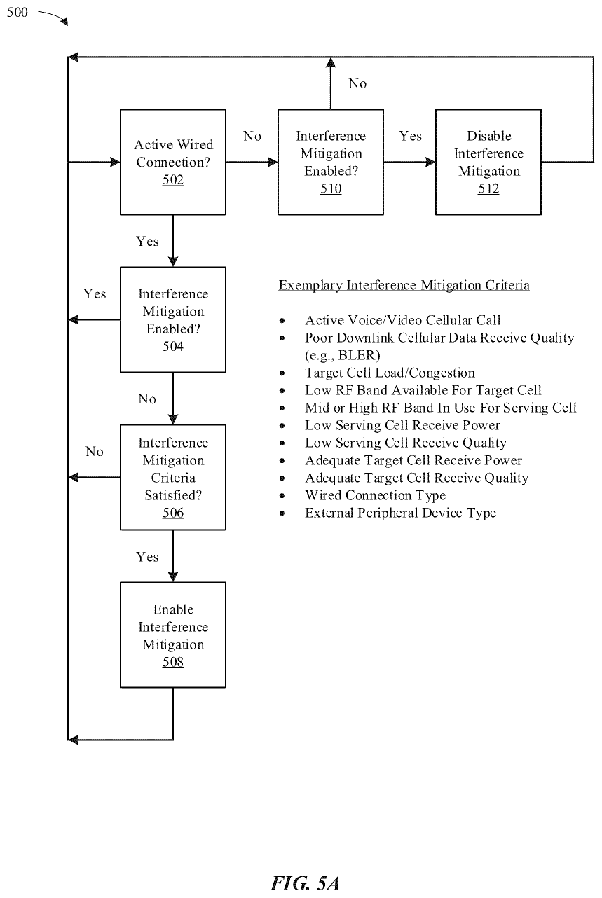

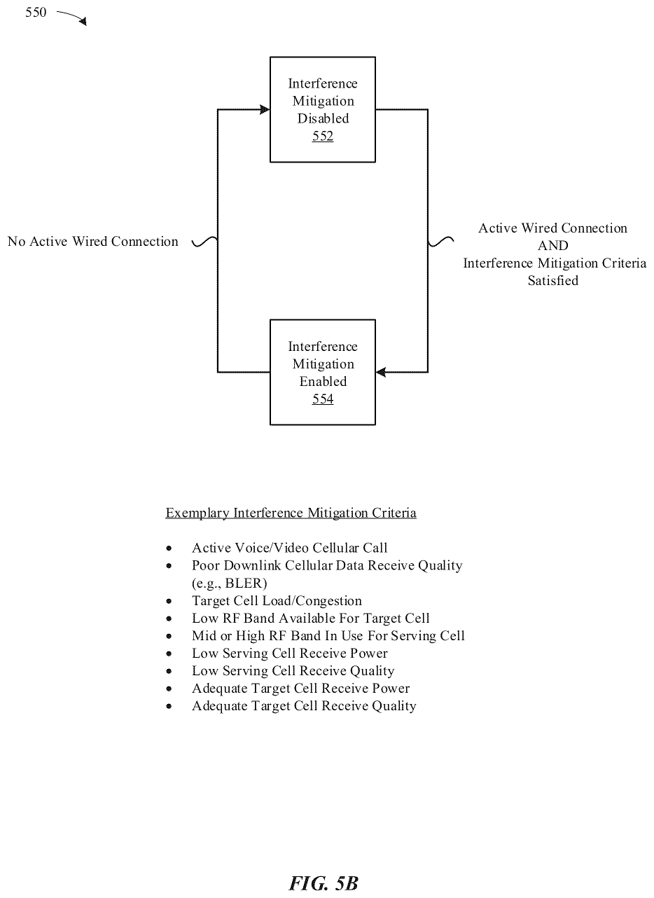

FIG. 5A illustrates a flowchart 500 of an example of interference mitigation managed by a wireless device 102. At 502, the wireless device 102 determines whether there is (or expected to be present imminently) an active wired connection 108 via a wired connection port 106 of the wireless device 102. When there is (or soon will be) an active wired connection 108 via the wired connection port 106, the wireless device 102 determines, at 504, whether interference mitigation to manage RF interference 110 from the wired connection 108 into a cellular wireless connection is enabled. When interference mitigation is already enabled, as determined at 504, the wireless device 102 returns to monitoring for the active wired connection status at 502. When interference mitigation has not been enabled, as determined at 504, the wireless device 102, at 506, determines whether one or more interference mitigation criteria are satisfied. Exemplary interference mitigation criteria include: i) an active cellular voice/video call, ii) poor downlink cellular data receive quality, e.g., BLER above a threshold, iii) target cell loading/congestion level, iv) availability of target cells in a low-frequency RF band, v) cellular connection to a current serving cell via a mid-frequency RF band or a high-frequency RF band, vi) low serving cell receive power, e.g., RSRP below a threshold, vii) low serving cell receive quality, e.g., RSRQ below a threshold, viii) adequate target cell receive power, e.g., RSRP above a threshold, ix) adequate target cell receive quality, e.g., RSRQ above a threshold, x) a type for the wired connection 108, xii) a type of external peripheral device using the wired connection 108. When a set of one or more interference mitigation criteria are satisfied, as determined at 506, the wireless device 102, at 508, enables interference mitigation to initiate an interference mitigation procedure (e.g., start boosting measurement report values for cells in a low-frequency RF band). When the set of one or more interference mitigation criteria are not satisfied, as determined at 506, the wireless device 102 returns to monitoring for an active (or imminently active) wired connection 108 at 502. When there is no active wired connection, as determined at 502, the wireless device 102 determines, at 510, whether interference mitigation has been enabled. When there is no interference mitigation enabled, as determined at 510, the wireless device 102 returns to monitoring for an active (or imminently active) wired connection 108 at 502. When interference mitigation is enabled, as determined at 510 (and there is not active wired connection 108), the wireless device 102, at 512 disables interference mitigation to terminate an ongoing interference mitigation procedure (e.g., stop boosting measurement report values for cells in a low-frequency RF band). In some embodiments, a type of wired connection 108 in use by a peripheral external device connected to the wireless device 102 is considered as part of the interference mitigation criteria, e.g., some types of wired connections may be observed (or known from previous observations) to not cause sufficient RF interference 110 into a cellular wireless connection to warrant switching RF bands. In some embodiments, a type of external peripheral device using the wired connection 108 can be considered as part of the interference mitigation criteria, e.g., different peripheral external devices can result in different amounts of RF interference 110 and thresholds for triggering interference mitigation (e.g., for signal strength and/or quality) or values for boosting measurement reports of target cells in low-frequency RF bands can be based at least in part on the type of wired connection 108 and/or the type of external peripheral device using the wired connection 108.

In some embodiments, for a cellular wireless data connection (rather than a voice/video call), with a serving cell via a mid-frequency RF band or a high-frequency RF band and impacted (or potentially impacted) by RF interference from a co-located wired connection 108, a wireless device 102 can first boost values for available low-frequency RF band target (neighbor) cells to trigger the cellular wireless network to handover the cellular wireless connection from the mid-frequency RF band or the high-frequency RF band serving cell to a low-frequency RF band target cell. In cases where the cellular wireless network does not handover the cellular wireless connection to the low-frequency RF band target cell, after a period of time, the wireless device 102 can trigger a re-establishment procedure to select anew the target cell as a serving cell during a cell selection process after terminating the cellular wireless data connection with current serving cell that uses the mid-frequency RF band or the high-frequency RF band. In some embodiments, the wireless device 102 measures and selects a target cell from multiple radio access technologies (RATs) available, e.g., measure a broad range of (or all) detected cells that use various RATs to select a target cell, even when the measured cells may not meet cell re-selection criteria, as normally configured by the cellular wireless network on which the wireless device 102 is camped. Measurement report values for a selected target cell can be boosted to ensure selection of the target cell, even though normal cell re-selection would not cause the cellular wireless network to move the wireless device 102 away from the current serving cell. The wireless device 102 can refrain from triggering a re-establishment procedure for the cellular wireless connection while an active voice/video call is ongoing to avoid interrupting the active voice/video call. In some embodiments, the wireless device 102 determines whether support for non-cellular wireless connections, e.g., Wi-Fi calling, is enabled and suitable Wi-Fi non-cellular networks detected and available and perform a cellular wireless to non-cellular wireless handover procedure to improve call quality of an active voice/video call that is impacted (or potentially impacted) by RF interference 110 from an active wired connection 108 via the wired connection port 106 of the wireless device 102.

FIG. 5B an exemplary state diagram 550 corresponding to the interference mitigation flowchart 500 of FIG. 5A. The wireless device 102 can initially have interference mitigation disabled at state 552. Responsive to detection of an active (or imminently active) wired connection 108 via a wired connection port 106 and when one or more interference mitigation criteria are satisfied, the wireless device 102 can transition to having interference mitigation enabled at state 554. The wireless device 102 can remain in state 554, with interference mitigation enabled until the active wired connection 108 terminates. In some embodiments, detection of the active (or imminently active) wired connection 108 and a parallel cellular wireless connection in a mid-frequency RF band or a high-frequency RF band can cause the wireless device 102 to perform measurements (and/or analyze previously obtained measurements) of target cells in a low-frequency RF band to locate a target cell that satisfies one or more interference mitigation criteria for handover of the cellular wireless connection.

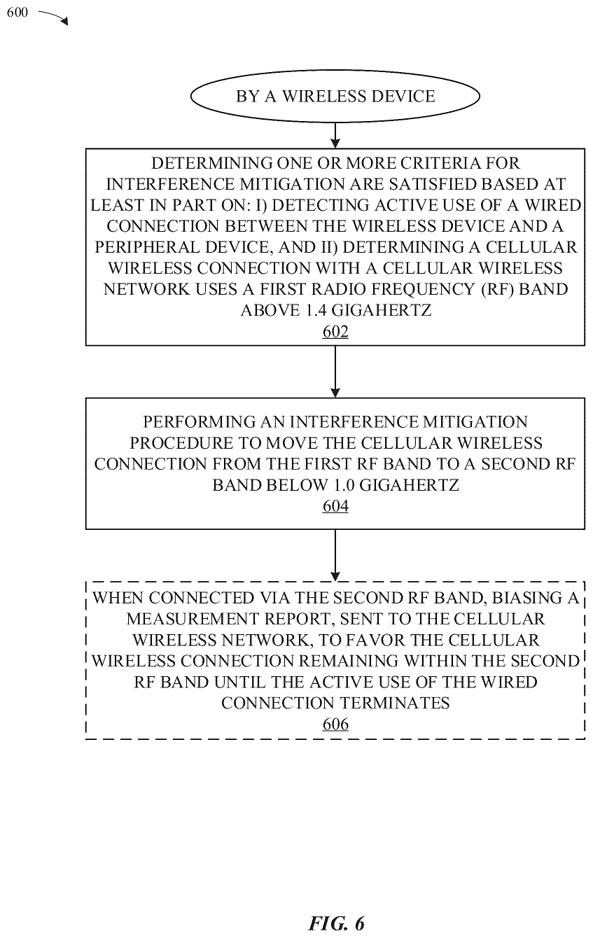

FIG. 6 illustrates a flowchart 600 of an exemplary method for interference mitigation performed by a wireless device 102. At 602, the wireless device 102 determines one or more criteria for interference mitigation are satisfied based at least in part on: i) detecting active use of a wired connection 108 between the wireless device 102 and a peripheral device, and ii) determining a cellular wireless connection with a cellular wireless network uses a first RF band above 1.4 GHz. At 604, the wireless device 102 performs an interference mitigation procedure to move the cellular wireless connection from the first RF band to a second RF band below 1.0 GHZ. In some embodiments, at 606, when the wireless device is connected via the second RF band, performing the interference mitigation procedure by the wireless device includes biasing a measurement report, sent to the cellular wireless network, to favor the cellular wireless connection remaining within the second RF band until the active use of the wired connection 108 terminates. The specific values for the first and second RF bands used can be configured to various ranges of RF frequencies, where a first range of RF frequencies for one or more RF bands can be considered mid-frequency RF bands and/or high-frequency RF bands in which cellular wireless communication can be more vulnerable to RF interference generated by a wired connection of a wireless device 102, and a second range of RF frequencies for one or more RF bands can be considered low-frequency RF bands in which cellular wireless communication can be less vulnerable to RF interference generated by a wired connection of a wireless device 102. Exemplary RF bands in a frequency range 1 (FR1) for 5G new radio (NR) cellular wireless communication can include: a low-frequency RF band below 1.0 GHz, a lower mid-frequency RF band from 1.4 to 1.5 GHZ, a mid-frequency RF band from 1.5 to 2.2 GHZ, a high-frequency RF band from 2.3 to 2.7 GHZ, a ultra-high RF band from 3.0 to 5.0 GHz. Additional exemplary RF bands in a frequency range 2 (FR2) can include RF bands above 24 GHZ. In general, the method for interference mitigation performed by a wireless device 102 described herein can apply to various RF bands where some RF bands are more vulnerable to RF interference from an active wired connection and other RF bands are less vulnerable to RF interference from the active wired connection, and the wireless device 102 is configured to mitigate RF interference from the active wired connection into cellular wireless reception by moving a cellular wireless connection from a more vulnerable RF band to a less vulnerable RF band, e.g., by biasing measurement reports to favor the less vulnerable RF band over the more vulnerable RF band, and to favor keeping the cellular wireless connection in the less vulnerable RF band, e.g., by continuing to bias measurement reports, until the wired connection is no longer active.

In some embodiments, the wireless device 102 determines the one or more criteria for interference mitigation are satisfied by at least determining a voice call or a video call is actively using the cellular wireless connection. In some embodiments, the wireless device 102 determines the one or more criteria for interference mitigation are satisfied by at least determining a downlink cellular data quality for the cellular wireless connection does not satisfy a data quality threshold. In some embodiments: i) the downlink cellular data quality includes a data block error rate (BLER), ii) the data quality threshold includes a data BLER threshold, and iii) the downlink cellular data quality exceeds the data BLER threshold. In some embodiments, the wireless device 102 performs the interference mitigation procedure by at least biasing a measurement report, sent to the cellular wireless network while connected via the first RF band, to prompt the cellular wireless network to handover the cellular wireless connection from a serving cell in the first RF band to a target cell in the second RF band. In some embodiments, the wireless device 102 determines the one or more criteria for interference mitigation are satisfied based additionally by i) determining a reference signal received power (RSRP) and/or reference signal received quality (RSRQ) for the cellular wireless connection via a serving cell satisfy corresponding serving cell RSRP and/or RSRQ thresholds, and ii) determining RSRP and/or RSRQ for a target cell in the second RF band satisfy corresponding target cell RSRP and/or RSRQ threshold. In some embodiments, the wireless device 102 determines the one or more criteria for interference mitigation are satisfied additionally based on determining, when the cellular wireless connection includes a data connection, cellular loading and/or congestion of the target cell in the second RF band does not exceed corresponding cellular loading and/or congestion of the serving cell in the first RF band. In some embodiments, the wireless device 102 performs measurements of reference signal received power (RSRP) and/or reference signal received quality (RSRQ) for one or more target cells that use a different radio access technology (RAT) than a currently used serving cell, where performing the interference mitigation procedure includes biasing a measurement report, sent to the cellular wireless network while connected via the first RF band, to prompt the cellular wireless network to handover the cellular wireless connection from a serving cell in the first RF band that uses a first RAT to a target cell in the second RF band that uses a second RAT. In some embodiments, active use of the wired connection between the wireless device and the peripheral device includes data transfer at a data rate of at least 5 Gbps. In some embodiments, the peripheral device includes an external storage device 124, e.g., a solid-state storage device (SSD), and the wireless device 102 detects the active use of the wired connection between the wireless device 102 and the peripheral device by at least detecting data transfer between the SSD and the wireless device 102 satisfying a data transfer rate threshold. In some embodiments, the data transfer rate threshold is at least 5 Gbps. In some embodiments, the peripheral device includes an external display 120, and the wireless device 102 detects the active use of the wired connection 108 between the wireless device 102 and the peripheral device by at least detecting data transfer to the external display 120. In some embodiments, the peripheral device includes a computing device 128, and the wireless device 102 detects the active use of the wired connection 108 between the wireless device 102 and the peripheral device by at least detecting data transfer via the wired connection 108 for a personal hotspot application on the wireless device 102.

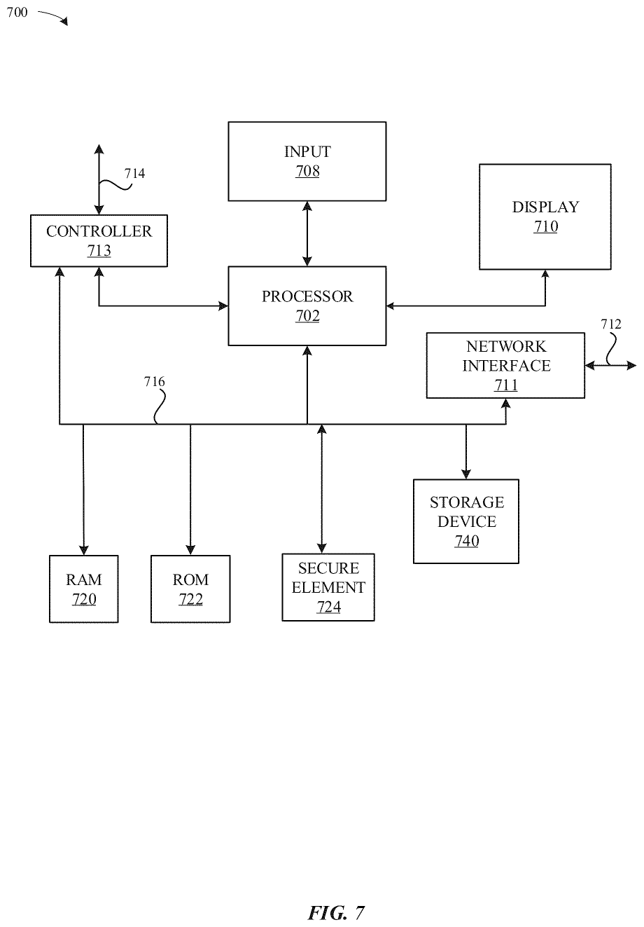

FIG. 7 illustrates a detailed view of a representative computing device 700 that can be used to implement various methods described herein, according to some embodiments. In particular, the detailed view illustrates various components that can be included in the wireless device 102, or any other wireless device as discussed herein. As shown in FIG. 7, the computing device 700 can include a processor 702 that represents a microprocessor or controller for controlling the overall operation of computing device 700. The computing device 700 can also include a user input device 708 that allows a user of the computing device 700 to interact with the computing device 700. For example, the user input device 708 can take a variety of forms, such as a button, keypad, dial, touch screen, audio input interface, visual/image capture input interface, input in the form of sensor data, etc. Still further, the computing device 700 can include a display 710 that can be controlled by the processor 702 to display information to the user. A data bus 716 can facilitate data transfer between at least a storage device 740, the processor 702, and a controller 713. The controller 713 can be used to interface with and control different equipment through an equipment control bus 714. The computing device 700 can also include a network/bus interface 711 that communicatively couples to a data link 712. In the case of a wireless connection, the network/bus interface 711 can include a wireless transceiver.

The computing device 700 also includes a storage device 740, which can include a single disk or a plurality of disks (e.g., hard drives), and includes a storage management module that manages one or more partitions within the storage device 740. In some embodiments, storage device 740 can include flash memory, semiconductor (solid state) memory or the like. The computing device 700 can also include a Random Access Memory (RAM) 720 and a Read-Only Memory (ROM) 722. The ROM 722 can store programs, utilities or processes to be executed in a non-volatile manner. The RAM 720 can provide volatile data storage, and stores instructions related to the operation of the computing device 700. The computing device 700 can further include a secure element (SE) 724, which can represent secure storage for credentials for cellular wireless system access by the computing device 700. The secure element 724 can include an eUICC on which to store one or more eSIMs, one or more UICCs that store SIM or eSIM credentials (profiles), and/or a processor and/or chip component in a system on chip (SoC) module that stores iSIM credentials (profiles).

### Wireless Terminology

In accordance with various embodiments described herein, the terms “wireless communication device,” “wireless device,” “mobile wireless device,” “mobile station,” and “user equipment” (UE) may be used interchangeably herein to describe one or more common consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near field communication (NFC), a cellular wireless network, a fourth generation (4G) Long Term Evolution (LTE), LTE Advanced (LTE-A), and/or fifth generation (5G) or other present or future developed advanced cellular wireless networks.

The wireless communication device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless communication device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless communication devices that are also capable of communicating via different third generation (3G) and/or second generation (2G) RATs. In these scenarios, a multi-mode UE can be configured to prefer attachment to LTE networks offering faster data rate throughput, as compared to other 3G legacy networks offering lower data rate throughputs. For instance, in some implementations, a multi-mode UE may be configured to fall back to a 3G legacy network, e.g., an Evolved High Speed Packet Access (HSPA+) network or a Code Division Multiple Access (CDMA) 2000 Evolution-Data Only (EV-DO) network, when LTE and LTE-A networks are otherwise unavailable.

Cellular wireless access credentials to provide access to cellular wireless services of a cellular wireless service provider can be installed in a wireless device in a variety of forms including but not limited to a universal integrated circuit card (UICC) storing a subscriber identity module (SIM), an embedded UICC (eUICC) storing an electronic SIM (eSIM), or in hardware, such as a processor of system on chip (SoC) module storing an integrated SIM (iSIM). The embodiments described herein can apply to all of these type of implementations. A UICC storing a SIM can also be referred to as a SIM card. A SIM, eSIM, or iSIM can also be referred to as a SIM profile, an eSIM profile, or an iSIM profile respectively, or simply as a profile.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

Regarding the present disclosure, it is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for mitigating radio frequency (RF) interference between a wired connection and a cellular wireless connection by a wireless device, the method comprising:
by the wireless device:
determining one or more criteria for interference mitigation are satisfied based at least in part on:
detecting active use of the wired connection between the wireless device and a peripheral device, and
determining the cellular wireless connection with a cellular wireless network uses a first RF band above 1.4 Gigahertz (GHz); and
performing an interference mitigation procedure to move the cellular wireless connection from the first RF band to a second RF band below 1.0 GHz.

2. The method of claim 1, wherein when the wireless device is connected via the second RF band, performing the interference mitigation procedure comprises biasing a measurement report, sent to the cellular wireless network to favor the cellular wireless connection remaining within the second RF band until the active use of the wired connection terminates.

3. The method of claim 1, wherein determining the one or more criteria for interference mitigation are satisfied further comprises determining a voice call or a video call is actively using the cellular wireless connection.

4. The method of claim 1, wherein determining the one or more criteria for interference mitigation are satisfied further comprises determining a downlink cellular data quality for the cellular wireless connection does not satisfy a data quality threshold.

5. The method of claim 4, wherein:
the downlink cellular data quality comprises a data block error rate (BLER),
the data quality threshold comprises a data BLER threshold; and
the downlink cellular data quality exceeds the data BLER threshold.

6. The method of claim 1, wherein performing the interference mitigation procedure comprises biasing a measurement report, sent to the cellular wireless network while connected via the first RF band, to prompt the cellular wireless network to handover the cellular wireless connection from a serving cell in the first RF band to a target cell in the second RF band.

7. The method of claim 1, wherein determining the one or more criteria for interference mitigation are satisfied further comprises:
determining a reference signal received power (RSRP) and/or reference signal received quality (RSRQ) for the cellular wireless connection via a serving cell satisfy corresponding serving cell RSRP and/or RSRQ thresholds; and
determining RSRP and/or RSRQ for a target cell in the second RF band satisfy corresponding target cell RSRP and/or RSRQ threshold.

8. The method of claim 7, wherein determining the one or more criteria for interference mitigation are satisfied further comprises:
determining, when the cellular wireless connection comprises a data connection, cellular loading and/or congestion of the target cell in the second RF band does not exceed corresponding cellular loading and/or congestion of the serving cell in the first RF band.

9. The method of claim 1, further comprising:
performing measurements of reference signal received power (RSRP) and/or reference signal received quality (RSRQ) for one or more target cells that use a different radio access technology (RAT) than a currently used serving cell, wherein
performing the interference mitigation procedure comprises biasing a measurement report, sent to the cellular wireless network while connected via the first RF band, to prompt the cellular wireless network to handover the cellular wireless connection from a serving cell in the first RF band that uses a first RAT to a target cell in the second RF band that uses a second RAT.

10. The method of claim 1, wherein active use of the wired connection between the wireless device and the peripheral device comprises data transfer at a data transfer rate of at least 5 Gbps.

11. The method of claim 1, wherein:
the peripheral device comprises a solid-state storage device (SSD); and
detecting the active use of the wired connection between the wireless device and the peripheral device comprises detecting data transfer between the SSD and the wireless device satisfying a data transfer rate threshold.

12. The method of claim 11, wherein the data transfer rate threshold is at least 5 Gbps.

13. The method of claim 1, wherein:
the peripheral device comprises an external display; and
detecting the active use of the wired connection between the wireless device and the peripheral device comprises detecting data transfer to the external display.

14. The method of claim 1, wherein:
the peripheral device comprises a computing device; and
detecting the active use of the wired connection between the wireless device and the peripheral device comprises detecting data transfer via the wired connection for a personal hotspot application on the wireless device.

15. A wireless device configured for mitigating radio frequency (RF) interference between a wired connection and a cellular wireless connection by a wireless device, the wireless device comprising:
wireless circuitry comprising one or more antennas; and
one or more processors communicatively coupled to the wireless circuitry and to a memory storing instructions that, when executed by the one or more processors, cause the wireless device to perform actions including:
determining one or more criteria for interference mitigation are satisfied based at least in part on:
detecting active use of the wired connection between the wireless device and a peripheral device, and
determining the cellular wireless connection with a cellular wireless network uses a first RF band above 1.4 Gigahertz (GHz); and
performing an interference mitigation procedure to move the cellular wireless connection from the first RF band to a second RF band below 1.0 GHz.

16. The wireless device of claim 15, wherein the wireless device, when connected via the second RF band, is configured to perform the interference mitigation procedure by at least biasing a measurement report, sent to the cellular wireless network to favor the cellular wireless connection remaining within the second RF band until the active use of the wired connection terminates.

17. The wireless device of claim 15, wherein the wireless device is configured to determine the one or more criteria for interference mitigation are satisfied by at least determining a voice call or a video call is actively using the cellular wireless connection.

18. The wireless device of claim 15, wherein the wireless device is configured to perform the interference mitigation procedure by at least biasing a measurement report, sent to the cellular wireless network while connected via the first RF band, to prompt the cellular wireless network to handover the cellular wireless connection from a serving cell in the first RF band to a target cell in the second RF band.

19. The wireless device of claim 15, wherein the wireless device is further configured to:
perform measurements of reference signal received power (RSRP) and/or reference signal received quality (RSRQ) for one or more target cells that use a different radio access technology (RAT) than a currently used serving cell, and
perform the interference mitigation procedure by at least biasing a measurement report, sent to the cellular wireless network while connected via the first RF band, to prompt the cellular wireless network to handover the cellular wireless connection from a serving cell in the first RF band that uses a first RAT to a target cell in the second RF band that uses a second RAT.

20. An apparatus for mitigating radio frequency (RF) interference between a wired connection and a cellular wireless connection by a wireless device, the apparatus comprising one or more processors communicatively coupled to a memory storing instructions that, when executed by the one or more processors, cause a wireless device to perform actions including:
determining one or more criteria for interference mitigation are satisfied based at least in part on:
detecting active use of the wired connection between the wireless device and a peripheral device, and
determining the cellular wireless connection with a cellular wireless network uses a first RF band above 1.4 Gigahertz (GHz); and
performing an interference mitigation procedure to move the cellular wireless connection from the first RF band to a second RF band below 1.0 GHz.
